(19) United States
(12) Patent Application Publication
(10) Pub. No.: US 2013/0126535 A1
(43) Pub. Date: May 23, 2013

(54) SUPPORTS ANCHORED WITH RIBS

(71) Applicants: Arne Barrett Sele, Hosle (NO); Trygve Johannes Lund, Oslo (NO)

(72) Inventors: Arne Barrett Sele, Hosle (NO); Trygve Johannes Lund, Oslo (NO)

(73) Assignee: AKER ENGINEERING & TECHNOLOGY AS, Lysaker (NO)

(21) Appl. No.: 13/505,279

(22) PCT Filed: Oct. 29, 2010
(86) PCT No.: PCT/NO2010/000389

§ 371 Date: Sep. 18, 2012

(30) Foreign Application Priority Data
Oct. 29, 2009 (NO) 20093246
Jul. 2, 2010 (NO) 20100971

(51) Int. Cl. F17C 1/00

(52) U.S. Cl. CPC F17C 1/002
USPC 220/562

(57) ABSTRACT

The present invention concerns a support arranged at the bottom of a tank subjected to thermal expansion and contraction, comprising a block (1) in contact with the bottom of the tank, means (3-5) being arranged to prevent movement at the tank with respect to the block (1) in a horizontal direction, wherein said means comprises a rib (5) arranged in one of said bottom of the tank and block (1) and a corresponding groove (4) in the other said bottom and block (1).

### FIELD OF INVENTION

The present invention relates to tanks for storage and transportation of fluids such as hydrocarbons, including low temperature liquefied natural gas. This includes tanks for ships and floating offshore structures exposed to wave loads as well as gravity based offshore structures and land tanks exposed to earthquakes.

### BACKGROUND OF THE INVENTION

Tanks may be designed in many different configurations, such as spheres, cylinders, cones and shells in general, as well as prismatic shapes. The principal advantage of prismatic shapes is that they nest closer to each other, minimising the volume taken up by such tanks.

Such tanks may be supported by timber of various types or similar materials. The present technology for anchoring such supports to the bottom of the tank is to weld on guide rails. For certain materials welds have considerably lower strength then the base metal which prevents full utilisation of the base metal. Welds are also more susceptible to fatigue. To avoid initiating cracks propagating from welds and propagating through the thickness of the shell the design is such that there are no welds in the webs of the H-beams making up the panels.

U.S. Pat. No. 5,531,178 discloses a support structure for LNG tanks. The bottom supports are restrained by guide rails. No description of how these guide rails are fastened to the bottom of the tank is provided.

WO 2008/133785 discloses a tank for transportation of LNG. The supports between the bottom of the tank and the floor of the ship hull are only described as “support chocks”, and there is no mention of how, or if, the supports are anchored to the tank.

### OBJECT OF THE INVENTION

The object of the present invention is to provide supports for tanks which avoid the problems regarding welds described above.

### SUMMARY OF THE INVENTION

The object of the present invention is obtained by anchoring the support blocks into welded box shaped containers with a groove matching the rib in the tank bottom or vice versa. This avoids welding onto the bottom structure of the tank. For certain materials welds have inferior strength. Welds are also far more susceptible to fatigue cracks which may propagate through thickness leading to leaks. Base metal is far less susceptible to fatigue and crack propagation. The invention is further defined by the following:

A support arranged at the bottom of a tank subjected to thermal expansion and contraction, comprising a block in contact with the bottom of the tank, means being arranged to prevent movement at the tank with respect to the block in a horizontal direction, wherein said means comprises a rib arranged in one of said bottom of the tank and block and a corresponding groove in the other said bottom and block.

In one embodiment of the present invention, the above-mentioned rib is depending from the bottom of the tank and is extending into a groove in the block.

In one embodiment of the present invention, the above-mentioned rib is extending from block into a groove in the bottom of the tank.

In one embodiment of the present invention, the above-mentioned rib forms part of an element of the bottom of the tank having welds to adjoining elements spaced from the rib.

In one embodiment of the present invention, the above-mentioned rib is a rolled or extruded part of the bottom.

### BRIEF DESCRIPTION OF THE DRAWINGS

Further details of the invention will be described below with reference to the exemplifying embodiments shown schematically in the appended drawings, wherein:

FIG. 1 shows a cross section of a support;

FIG. 2 shows a detail of the cross section in FIG. 1;

FIG. 3 shows a cross section of an alternate embodiment of a support wherein the location of the rib and the groove are reversed.

FIG. 4 shows an isometric drawing of a tank featuring supports on the bottom of the tank.

### DETAILED DESCRIPTION OF THE DRAWINGS

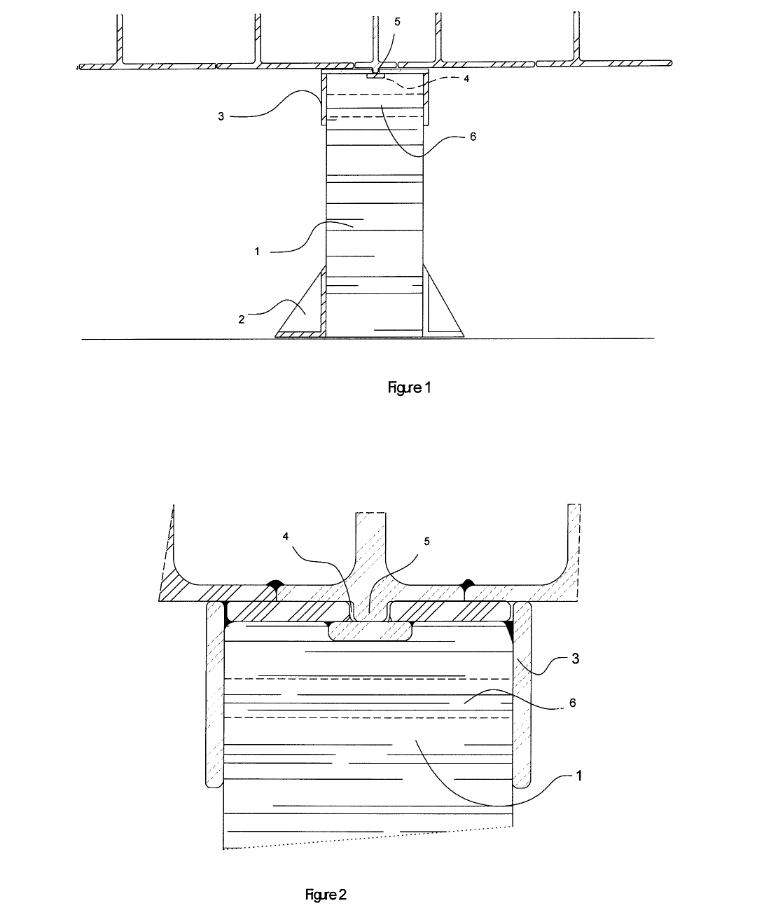

FIG. 1 shows a cross section of a support. The support block 1 is made from timber, laminated timber or other suitable material. The supports are constrained by brackets or rails 2 welded to the hull. The top part of the support block is confined inside a box 3 assembled from plate including a bracket 6. The box includes a groove 4 into which a rib 5 may be anchored. The rib 5 may be rolled or extruded as part of the plate or cross section making up the bottom structure of the tank. This provides a base metal structural detail preventing the need for welding onto the bottom of the tank.

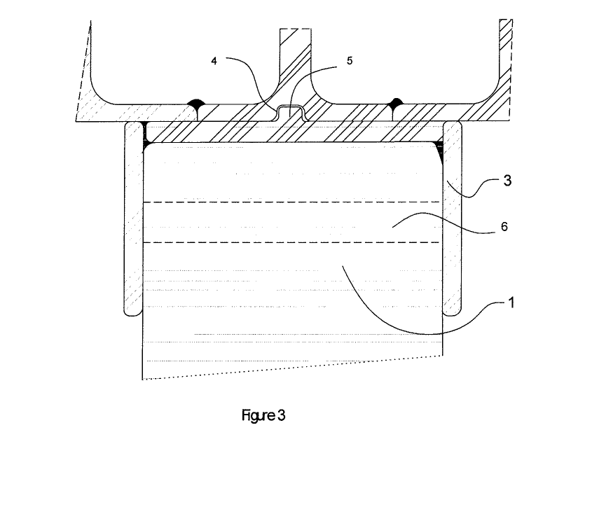

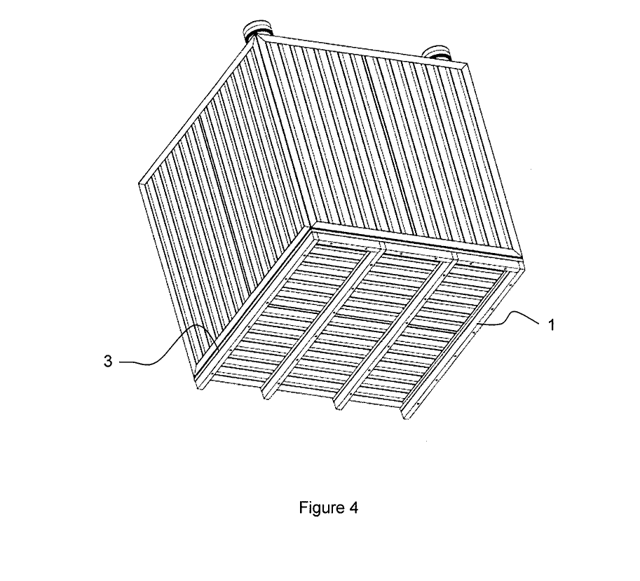

FIG. 2 shows the detail around the rib 5 and groove 4.

FIG. 3 shows a cross section of an alternate embodiment of a support wherein the location of the rib 5 and the groove 4 is reversed.

1. A tank subjected to thermal expansion and contraction comprising a support arranged at the bottom of the tank, the support comprising a block in contact with the bottom of the tank, means for preventing movement of the tank with respect to the block in a horizontal direction, said means comprising a rib arranged in one of said bottom of the tank and block, and a corresponding groove in the other of said bottom and block.

2. A tank according to claim 1, wherein the rib is depending from the bottom of the tank and is extending into a groove in the block.

3. A tank according to claim 1, wherein the rib is extending from the block into a groove in the bottom of the tank.

4. A tank according to claim 2, wherein the rib forms part of an element of the bottom of the tank having welds to adjoining elements of the tank spaced from the rib.

5. A tank according to claim 2, wherein the rib is a rolled or extruded part of the bottom.
